(19) United States
(12) Patent Application Publication
(10) Pub. No.: US 2025/0378787 A1
(43) Pub. Date: Dec. 11, 2025

(54) ELECTROLUMINESCENT DISPLAY APPARATUS AND DRIVING METHOD THEREOF

(71) Applicant: LG Display Co., Ltd., Seoul (KR)

(72) Inventors: Ki Tae KWON, Paju-si (KR); Jong Wook JANG, Paju-si (KR); Dae Ho PARK, Paju-si (KR)

(73) Assignee: LG Display Co., Ltd., Seoul (KR)

(21) Appl. No.: 19/229,030

(22) Filed: Jun. 5, 2025

(30) Foreign Application Priority Data
Jun. 11, 2024 (KR) 10-2024-0075763

(51) Int. Cl. G09G 3/3233

(52) U.S. Cl. CPC G09G 3/3233; G09G 2300/0819; G09G 2300/0842; G09G 2300/0861; G09G 2310/08; G09G 2320/0233; G09G 2320/0247; G09G 2320/045; G09G 2340/0435

(57) ABSTRACT

An electroluminescent display apparatus includes a display panel including a plurality of pixels and a driving circuit configured to drive the display panel. Each of the plurality of pixels includes a light emitting device; a driving transistor configured to generate a driving current to be supplied to the light emitting device; a driving transistor controller including a capacitor, including one electrode connected to a first node charged with a data voltage and the other electrode connected to a second node connected to a gate electrode of the driving transistor, and a plurality of transistors configured to control a current flowing in the driving transistor; and an initialization switch configured to initialize a third node connected to an anode electrode of the light emitting device in response to a second gate control signal differing from the first gate control signal, in a skip frame period after the refresh frame period.

### CROSS-REFERENCE TO RELATED APPLICATION

This application claims the benefit of Korean Patent Application No. 10-2024-0075763, filed on Jun. 11, 2024, which is hereby incorporated by reference as if fully set forth herein.

### BACKGROUND

### Field

The present disclosure relates to an electroluminescent display apparatus and a driving method thereof.

### Discussion of the Related Art

Electroluminescent display apparatuses include pixels which are arranged as a matrix type and implement luminance corresponding to image data by using the pixels. In electroluminescent display apparatuses, technology which varies a refresh rate based on an attribute of an image has been known. Refresh rate variable technology increases a data refresh cycle as a variation of an image is reduced, and thus, decreases power consumption.

A data refresh operation is performed in a refresh frame and is skipped in a skip frame. Therefore, as the number of skip frames disposed between adjacent refresh frames increases, a data refresh cycle may increase, and low speed driving may be implemented.

A luminance deviation between the refresh frame and the skip frame may be caused by a connection structure of a pixel circuit. That is, according to a conventional pixel circuit, an initialization operation on a light emitting diode may not be sufficient in the skip frame, and due to this, the luminance deviation between the refresh frame and the skip frame may occur.

Such a luminance deviation may more seriously appear in low-speed driving where a data refresh cycle is long, and due to this, may be recognized as flicker to a user.

### SUMMARY

Accordingly, the present disclosure is directed to a display apparatus that substantially obviates one or more problems due to limitations and disadvantages of the related art.

To overcome the aforementioned problem of the related art, the present disclosure may provide an electroluminescent display apparatus and a driving method thereof, which may minimize or reduce a luminance deviation between a refresh frame and a skip frame.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, an electroluminescent display apparatus includes a display panel including a plurality of pixels and a driving circuit configured to drive the display panel, wherein each of the plurality of pixels includes a light emitting device, a driving transistor configured to generate a driving current which is to be supplied to the light emitting device, a driving transistor controller including a capacitor, including one electrode connected to a first node charged with a data voltage corresponding to image data in a refresh frame period and the other electrode connected to a second node connected to a gate electrode of the driving transistor, and a plurality of transistors configured to control a current flowing in the driving transistor, and an initialization switch configured to initialize a third node connected to an anode electrode of the light emitting device in response to a second gate control signal differing from the first gate control signal, in a skip frame period after the refresh frame period.

In another aspect of the present disclosure, a driving method of an electroluminescent display apparatus includes a first initialization operation of initializing the first node with a first voltage and initializing the second and third nodes with a second voltage in a refresh frame period, a programming operation of setting a programming voltage, including a threshold voltage of the driving transistor, in the second node in the refresh frame period, a first emission operation of emitting light by using the light emitting device with the programming voltage of the second node in the refresh frame period, a second initialization operation of initializing the third node with the second voltage in a skip frame period after the refresh frame period, and a second emission operation of emitting light by using the light emitting device with the programming voltage of the second node in the skip frame period, wherein the second node is floated in the second initialization operation.

It is to be understood that both the foregoing general description and the following detailed description of the present disclosure are by way of example and are intended to provide further explanation of the disclosures as claimed.

### BRIEF DESCRIPTION OF THE DRAWINGS

The accompanying drawings, which are included to provide a further understanding of the present disclosure and are incorporated in and constitute a part of this application, illustrate example embodiment(s) of the disclosure and together with the description serve to explain various principles of the present disclosure. In the drawings:

FIG. 1 is a block diagram for describing an entire configuration of an electroluminescent display apparatus according to an example embodiment of the present disclosure;

FIG. 2 is a diagram for describing an example embodiment of a pixel array included in a display panel illustrated in FIG. 1;

FIG. 3 is a diagram for describing in more detail gate lines illustrated in FIG. 2;

FIG. 4 is a diagram for describing an example of refresh rate variable technology applied to a display apparatus according to an example embodiment of the present disclosure;

FIG. 5 is a diagram for describing an example of a pixel circuit according to an example embodiment of the present disclosure;

FIG. 6 is a diagram for describing an example of a driving timing diagram for operating the pixel circuit illustrated in FIG. 5;

FIGS. 7 to 11 are diagrams for describing a pixel operation of FIG. 5 with respect to a driving timing of FIG. 6;

FIG. 12 is a diagram for describing an example of a pixel and an example of a driving timing according to a comparative example;

FIG. 13 is a diagram for describing a comparison of effects of a pixel circuit according to the comparative example of FIG. 12 and a pixel circuit according to the example embodiment of FIG. 5;

FIG. 14 is a diagram for describing a first example embodiment of a setting of a second voltage and a setting of a gate on period of an initialization switch illustrated in FIGS. 4 and 5;

FIG. 15 is a diagram for describing a second example embodiment of a setting of the second voltage and a setting of a length of the gate on period of the initialization switch illustrated in FIGS. 4 and 5; and

FIG. 16 is a diagram for describing a third example embodiment of a setting of the second voltage and a setting of a length of the gate on period of the initialization switch illustrated in FIGS. 4 and 5.

### DETAILED DESCRIPTION

Hereinafter, example embodiments of the present disclosure will be described in detail with reference to the accompanying drawings. In the specification, in adding reference numerals for elements in each drawing, it should be noted that like reference numerals already used to denote like elements in other drawings are used for elements wherever possible. In the following description, where the detailed description of the relevant known function or configuration may unnecessarily obscure features of the present disclosure, the detailed description may be omitted.

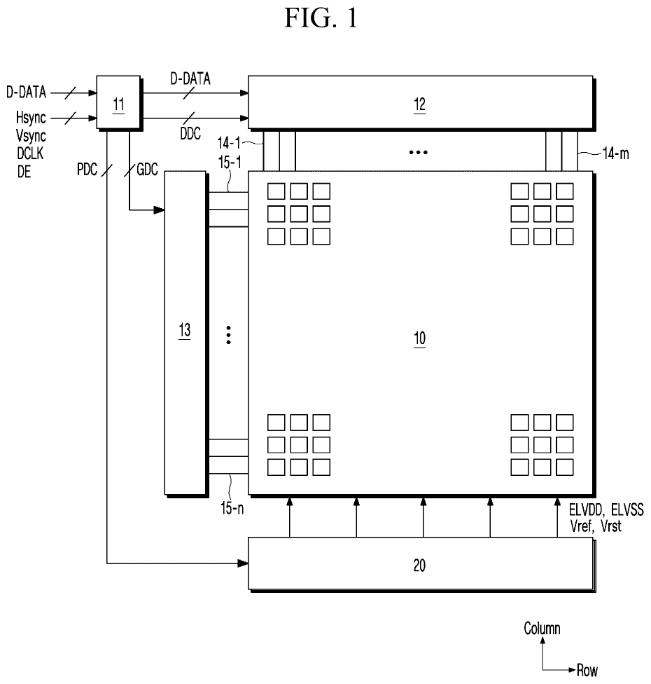

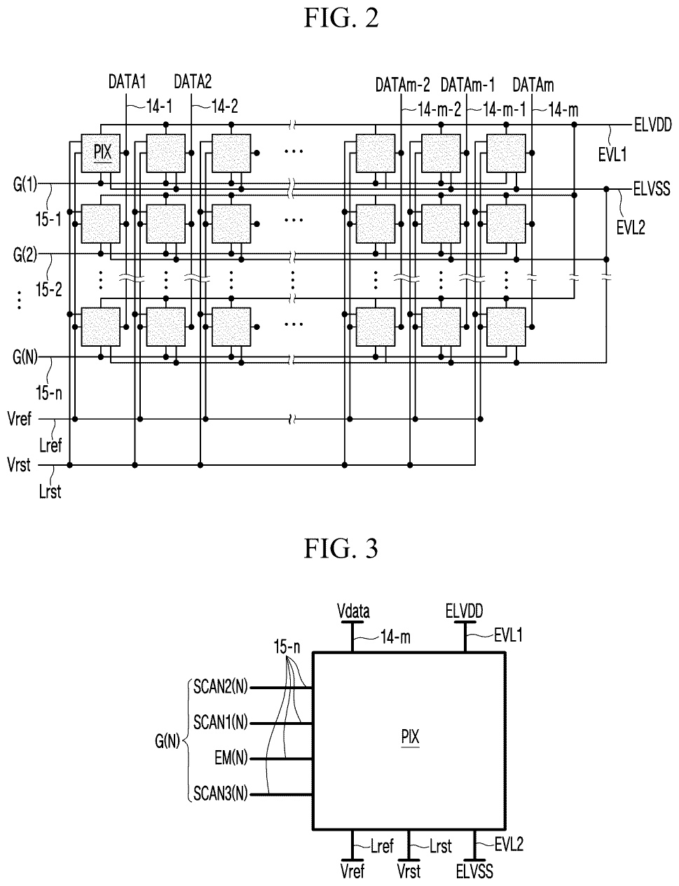

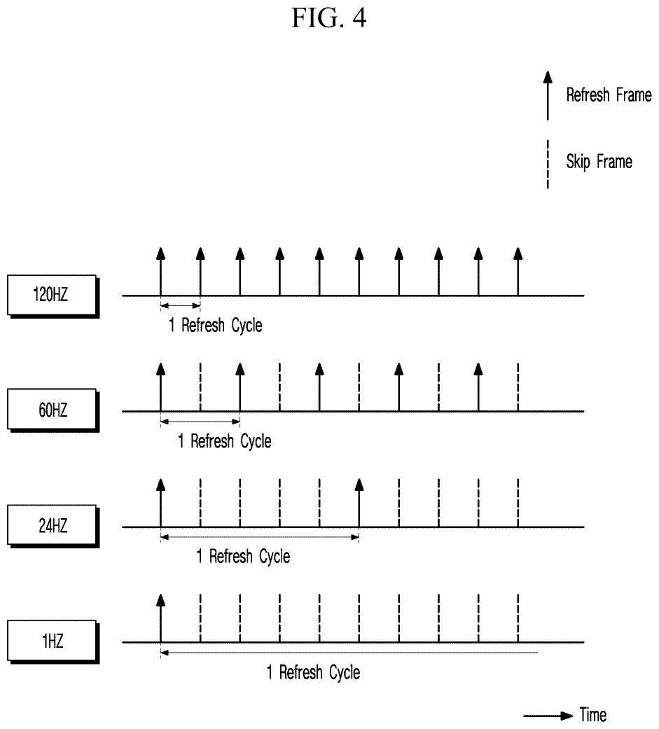

FIG. 1 is a block diagram for describing an entire configuration of an electroluminescent display apparatus according to an example embodiment of the present disclosure, FIG. 2 is a diagram for describing an example embodiment of a pixel array included in a display panel 10 illustrated in FIG. 1, and FIG. 3 is a diagram for describing in more detail gate lines illustrated in FIG. 2.

As shown in FIGS. 1 to 3, the electroluminescent display apparatus according to an embodiment of the present disclosure may include the display panel 10, a timing controller 11, a data driver 12, a gate driver 13, and a power circuit 20.

In FIG. 1, all or some of the timing controller 11, the data driver 12, and the power circuit 20 may be integrated into a drive integrated circuit (IC). In FIG. 1, the data driver 12, the gate driver 13, and the power circuit 20 may configure a panel driving circuit. The panel driving circuit may be connected to a pixel array of the display panel 10 through a plurality of signal lines 14, 15, EVL1, EVL2, Lref, and Lrst.

As shown in FIGS. 1 to 3, the display panel 10 may include a pixel array for displaying an input image. In the pixel array, data lines 14 extending in a column direction (or a vertical direction) may intersect gate lines 15 extending in a row direction (or a horizontal direction), and pixels PIX may be arranged as a matrix type in intersection areas between the data lines 14 and the gate lines 15.

Each of the data lines 14 may be connected to pixels PIX adjacent to each other in the column direction in common, and each of the gate lines 15 may be connected to pixels PIX adjacent to each other in the row direction in common. As in FIG. 2, data lines 14-1 to 14-m may be electrically disconnected from each other, and gate lines 15-1 to 15-n may also be electrically disconnected from each other.

Gate control signals G(1) to G(N) based on corresponding gate lines 15-1 to 15-n may be respectively applied to the gate lines 15-1 to 15-n.

As illustrated in FIG. 3, the gate line 15-n connected to each pixel may include a line to which a first scan signal SCAN1(N) is applied, a line to which a second scan signal SCAN2(N) is applied, a line to which an emission control signal EM(N) is applied, and a line to which a third scan signal SCAN3(N) is applied.

The gate control signal G(N) may be classified into a first gate control signal, including the first and second scan signals SCAN1(N) and SCAN2(N) and the emission control signal EM(N), and a second gate control signal including the third scan signal SCAN3(N).

The pixel array may further include a first power line EVL1, a second power line EVL2, a first voltage source line Lref, and a second voltage source line Lrst, which are connected to all pixels PIX in common.

A high-level voltage source ELVDD may be connected to the first power line EVL1, a low-level voltage source ELVSS may be connected to the second power line EVL2, a first voltage Vref source may be connected to the first voltage source line Lref, and a second voltage Vrst source may be connected to the second voltage source line Lrst.

A high-level voltage source may supply a high-level voltage ELVDD, a low-level voltage source may supply a low-level voltage ELVSS, the first voltage source may supply a first voltage Vref, and the second voltage source may supply a second voltage Vrst.

The high-level voltage ELVDD and the low-level voltage ELVSS may be used as voltages for allowing a light emitting device to emit light. The first voltage Vref may be, for example, a reference voltage and may be used as a voltage for initializing one electrode of a capacitor included in a pixel circuit. The second voltage Vrst may be, for example, a reset voltage, may have a voltage of a level which differs from that of the first voltage Vref, and may be used as a voltage for initializing the other electrode of the capacitor included in the pixel circuit, a driving transistor, and a node connected to an anode electrode of the light emitting device.

The pixels PIX included in the pixel array may be grouped into a plurality of pixel groups and may display various colors. In a case where a pixel group for color expression is defined as a unit pixel, one unit pixel may be configured to include red (R), green (G), and blue (B) pixels PIX, or may be configured to include red (R), green (G), blue (B), and white (W) pixels PIX.

Each of the pixels PIX may be implemented with a pixel circuit which includes a light emitting device, a driving transistor, and one or more switching transistors and capacitors.

The light emitting device may be implemented as an organic light emitting diode (OLED). The light emitting device may include an anode electrode, a cathode electrode, and an organic compound layer formed between the electrodes. The organic compound layer may include a hole injection layer (HIL), a hole transport layer (HTL), an emission layer (EML), an electron transport layer (ETL), and an electron injection layer (EIL), but is not limited thereto.

When a pixel current flows in the light emitting device, a hole passing through the hole transport layer (HTL) and an electron passing through the electron transport layer (ETL) may move to the emission layer (EML) to generate an exciton, and thus, the emission layer (EML) may emit visible light. Also, the organic compound layer may be replaced with an inorganic compound layer.

The driving transistor may generate a driving current which is to be supplied to the light emitting device. The driving current may be controlled based on a gate-source voltage of the driving transistor. The gate-source voltage between the driving transistor may be determined based on a data voltage Vdata corresponding to image data DATA.

The driving transistor may be implemented with a low temperature polysilicon (LTPS) or oxide thin film transistor based on an organic substrate (or a plastic substrate), but is not limited thereto. The driving transistor may be implemented with a complementary metal oxide semiconductor (CMOS) transistor based on a silicon wafer (Si-wafer).

In the driving transistor, an electrical characteristic (for example, a threshold voltage and electron mobility) thereof should be uniform in all pixels, but there may be a difference between the pixels PIX due to a process deviation and a device characteristic deviation.

The electrical characteristic of the driving transistor may vary as a display driving time elapses, and moreover, there may be a difference between the pixels PIX in degree of degradation. To compensate for the electrical characteristic deviation of the driving transistor, an internal compensation method may be applied to an electroluminescent display apparatus.

The internal compensation method may compensate for an electrical characteristic variation of the driving transistor by using a plurality of switching transistors and at least one capacitor included in the pixel circuit so that the electrical characteristic variation of the driving transistor does not affect an emission current.

Attempts to implement some elements (particularly, a switching transistor where a source or a drain thereof is connected to a gate of the driving transistor) included in the pixel circuit by using an oxide transistor are increasing. The oxide transistor may use oxide instead of poly-silicone, and for example, may use IGZO where indium (In), gallium (Ga), zinc (Zn), and oxygen (O) are bonded to one another.

The oxide transistor may be 10 or more times higher in electron mobility than an amorphous silicon transistor and may be far lower in manufacturing cost than the LTPS transistor. Also, because the oxide transistor is low in off current, the driving stability and reliability of the oxide transistor may be high in low-speed driving where an off period of a transistor is relatively long. Accordingly, the oxide transistor may be applied to an OLED television (TV) which may need a high resolution and low-power driving or may not respond to a screen size through an LTPS process.

In the present embodiment, to increase driving stability and the reliability of compensation, each of the driving transistor and the switching transistors included in the pixel circuit of each pixel PIX may be implemented as a P-channel (PMOS) transistor.

A transistor may be a three-electrode element including a gate, a source, and a drain. The source may be an electrode which provides a carrier to the transistor. In the transistor, the carrier may start to flow from the source. The drain may be an electrode where the carrier flows from the transistor to the outside. In the transistor, the carrier flows from the source to the drain.

In a P-channel transistor, because a carrier is a hole, a source voltage may be higher than a drain voltage so that the hole flows from the source to the drain. In the P-channel transistor, because the hole flows from the source to the drain, a current may flow from the source to the drain.

Furthermore, it should be noted that a source and a drain of a transistor are not fixed. For example, the source and the drain may be changed based on an applied voltage. Accordingly, the inventive concept is not limited to the source and the drain of the transistor.

The pixel circuit may sample a threshold voltage of the driving transistor in the middle of a programming operation which is performed in a frame period and may allow a sampled threshold voltage to be reflected in a gate-source voltage (hereinafter referred to as Vgs) of the driving transistor, and thus, may prevent a driving current from being distorted due to a threshold voltage variation of the driving transistor.

The pixel circuit may be driven based on refresh rate variable technology. To implement the refresh rate variable technology, one or more skip frames may be provided between adjacent refresh frames. A refresh rate (i.e., a frame frequency) may be determined based on the number of skip frames provided between adjacent refresh frames.

The refresh frame may include a first initialization period, a programming period, and a first emission period, and a data refresh operation of writing a data voltage to the pixel circuit through the programming period may be performed. The light emitting device may be turned off in the first initialization period and the programming period, and at this time, a gate electrode of a driving transistor, a capacitor, and an anode electrode of a light emitting device may be initialized.

The skip frame may not include the programming period where the data refresh operation is performed. That is, the programming period may be skipped in the skip frame. The skip frame may include a second initialization period and a second emission period. A programming voltage Vgs, which is set in a gate electrode of a driving transistor, may be maintained in the skip frame in the refresh frame period, and thus, a light emitting device may emit light with a corresponding programming voltage in the second emission period. In the second initialization period of the skip frame, an anode electrode of the light emitting device except a capacitor and the gate electrode of the driving transistor may be initialized.

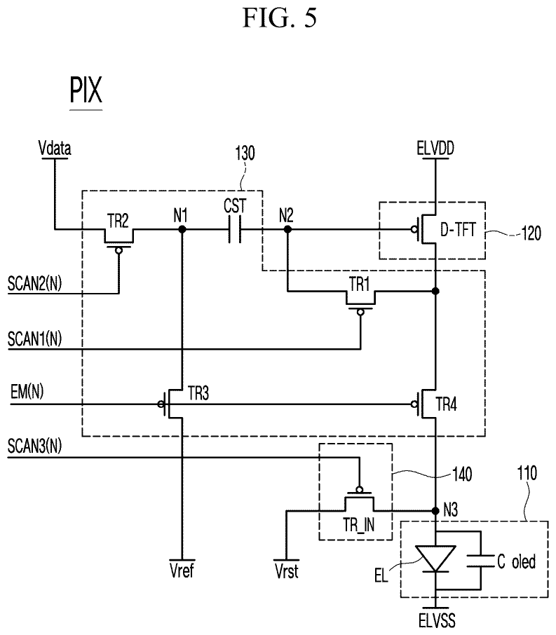

A pixel circuit operation in the refresh frame and the skip frame will be described below in detail with reference to FIG. 5.

The timing controller 11 may supply digital video data D-DATA, transferred from a host system (not shown), to the data driver 12. As shown in FIGS. 1 to 3, the timing controller 11 may receive a timing signal such as a vertical synchronization signal Vsync, a horizontal synchronization signal Hsync, a data enable signal DE, and a dot clock DCLK from the host system to generate timing control signals for controlling an operation timing of a panel driving circuit.

The timing control signals may include a gate timing control signal GDC for controlling an operation timing of the gate driver 13, a data timing control signal DDC for controlling an operation timing of the data driver 12, and a power timing control signal PDC for controlling an operation timing of the power circuit 20.

The timing controller 11 may control operations of the panel driving circuit 12, 13, and 20 so that low frequency driving or low speed driving including a refresh frame and a skip frame are implemented. To this end, the timing controller 11 may temporally divide a refresh frame period into a first initialization period, a programming period, and a first emission period and may temporally divide a skip frame period into a second initialization period and a second emission period.

The timing controller 11 may control an operation of the panel driving circuit 12, 13, and 20 so that all pixels PIX are initialized in the first and second initialization periods. The timing controller 11 may control an operation of the panel driving circuit 12, 13, and 20 so that the pixels PIX are programmed in a predetermined order in the programming period. The timing controller 11 may control an operation of the panel driving circuit 12, 13, and 20 so that the pixels PIX emit lights in a predetermined order in the first and second emission periods.

As shown in FIGS. 1 to 3, the data driver 12 may be connected to the pixels PIX through data lines 14-1 to 14-m. The data driver 12 may generate analog voltages DATA1 to DATAm needed for driving of the pixels PIX to supply the analog voltages DATA1 to DATAm to the data lines 14-1 to 14-m, based on digital image data D-DATA input from the timing controller 11. Each of the analog voltages DATA1 to DATAm may include a data voltage Vdata.

The data driver 12 may sample and latch the digital image data D-DATA input from the timing controller 11 to generate parallel data, based on the data timing control signal DDC, and a digital-to-analog converter (DAC) may convert the digital image data D-DATA into analog data voltages Vdata, based on gamma compensation voltages, and may respectively supply the analog data voltages Vdata to the pixels PIX through the data lines 14. The analog data voltages Vdata may be analog voltage values of different voltage levels to correspond to image gray levels which are to be expressed in the pixels PIX.

The data driver 12 may output the data voltages Vdata to the pixels PIX in the programming period, based on the data timing control signal DDC. The data driver 12 may be configured with a plurality of source driver integrated circuits (ICs). Each of the source driver ICs may include a shift register, a latch, a level shifter, the DAC, and an output buffer.

The gate driver 13 may generate gate control signals G(1) to G(N) to supply the gate control signals G(1) to G(N) to the gate lines 15-1 to 15-n, based on the gate timing control signal GDC. Each of the gate control signals G(1) to G(N) may be generated as a pulse type which swings between a gate on voltage LON and a gate off voltage LOFF.

A transistor may be turned on in response to the gate on voltage LON and may be turned off in response to the gate off voltage LOFF. For example, in a P-channel transistor, the gate on voltage LON may be a low-level voltage, and the gate off voltage LOFF may be a high-level voltage.

The gate driver 13 may generate the gate control signals G(1) to G(N) of a pulse type which swings between the gate on voltage LON and the gate off voltage LOFF, based on the gate timing control signal GDC, and may allow an output timing of each of the gate control signals G(1) to G(N) to correspond to a supply timing of a data voltage.

In other words, the gate driver 13 may supply the gate control signals G(1) to G(N) of the gate on voltage LON to the gate lines 15-1 to 15-n so as to perform a data refresh operation in a programming period of a refresh frame, and in the skip frame, the gate control signals for performing the data refresh operation may be maintained to be the gate off voltage LOFF.

The gate driver 13 may apply, to the pixel circuit, the first to third scan signals SCAN1(N), SCAN2(N), and SCAN3(N) and the emission control signal EM(N) needed according to the first initialization period and the first emission period of the refresh frame and the second initialization period and the second emission period of the skip frame. This will be described below in detail with reference to FIG. 5.

The gate driver 13 may be configured with a plurality of gate drive ICs each including a gate shift register, a level shifter for changing an output signal of the gate shift register with a swing width suitable for driving of a transistor a pixel, and an output buffer.

Alternatively, the gate driver 13 may be formed directly on a substrate of the display panel 10, based on a gate driver in panel (GIP) type. In the GIP type, the level shifter may be mounted on a printed circuit board (PCB), and the gate shift register may be formed in a bezel region which is a non-display area of the display panel 10. The gate shift register may include a plurality of scan output stages which are connected to each other in cascade. The scan output stages may be independently connected to the gate lines 15-1 to 15-n and may output the gate control signal G(1) to G(N) to the gate lines 15-1 to 15-n.

As shown in FIGS. 1 to 3, the first power line EVL1, the second power line EVL2, the first voltage source line Lref, and the second voltage source line Lrst may extend from the power circuit 20 and may be connected to all pixels PIX.

Based on the power timing control signal PDC, the power circuit 20 may process an input power to generate a fixed high-level voltage ELVDD and may supply the high-level voltage ELVDD to the pixels PIX through the first power line ELV1. Also, based on the power timing control signal PDC, the power circuit 20 may process an input power to generate a fixed low-level voltage ELVSS which is fixed to be a level which is lower than the high-level voltage ELVDD and may supply the low-level voltage ELVSS to the pixels PIX through the second power line ELV2. The high-level voltage ELVDD and the low-level voltage ELVSS may be used as a voltage for allowing the light emitting device to emit light.

Based on the power timing control signal PDC, the power circuit 20 may process the input power to generate the first voltage Vref (for example, a reference voltage) and may supply the first voltage Vref to the pixels PIX through the first voltage source line Lef. Also, based on the power timing control signal PDC, the power circuit 20 may process the input power to generate the second voltage Vrst (for example, a reset voltage) having a level which differs from that of the first voltage Vref and may supply the second voltage Vrst to the pixels PIX through the second voltage source line Lrst.

The first voltage Vref and the second voltage Vrst may have different voltage levels. The second voltage Vrst may be higher or lower than the first voltage Vref, based on a characteristic of the display panel 10. A voltage level of the first voltage Vref may be fixed in the refresh frame and the skip frame, and in the second voltage Vrst, voltage levels may be equal to or different from each other in the refresh frame and the skip frame.

The first voltage Vref and the second voltage Vrst may have a level which is lower than that of the low-level voltage ELVSS. Accordingly, undesired emission of light by the pixels PIX may be prevented in the initialization period and the programming period of the refresh frame and the second initialization period of the skip frame.

The host system may be an application processor (AP) applied to mobile devices, wearable devices, and virtual/augmented reality (VR/AR) devices. Also, the host system may be a main board of television systems, set-top box, navigation systems, personal computers, and home theater systems, but is not limited thereto.

FIG. 4 is a diagram for describing an embodiment of refresh rate variable technology applied to a display apparatus according to the present disclosure.

A data refresh cycle of writing data voltages Vdata of an input image in the pixels PIX of the display panel 10 may vary based on an attribute of the input image. The data refresh cycle may be shortened when the amount of variation of an image is large, and when the amount of variation of an image is small, the data refresh cycle may increase. As the data refresh cycle increases, low speed driving may be performed, and as the data refresh cycle is shortened, high speed driving may be performed.

As shown in FIG. 4, the data refresh cycle may be 1/frame frequency. For example, the data refresh cycle may be 1 sec/120 in 120 Hz, 1 sec/60 in 60 Hz, 1 sec/24 in 24 Hz, and 1 sec in 1 Hz.

The number of skip frames disposed between two adjacent refresh frames may vary based on a frame frequency. For example, the number of skip frames may be 0 in 120 Hz, 1 in 60 Hz, 4 in 24 Hz, and 119 in 1 Hz.

As described above, a skip frame may be arranged between refresh frames, and thus, a programming period of the refresh frame may be skipped, thereby reducing power consumption. However, as described above, in a case where low speed driving is performed as the data refresh cycle increases, when a luminance deviation between the refresh frame and the skip frame does not occur or is minimized, the quality of an image may be enhanced.

When a luminance difference between lights emitted from the light emitting device in the refresh frame and the skip frame is minimized, the luminance device described above may be minimized. To this end, the present disclosure may provide a pixel circuit and a driving method thereof, where a programming voltage applied to a gate electrode of a driving transistor may be equally maintained in a first emission period of the refresh frame and a second emission period of the skip frame. The pixel circuit and the driving method thereof will be described below in detail with reference to FIG. 5.

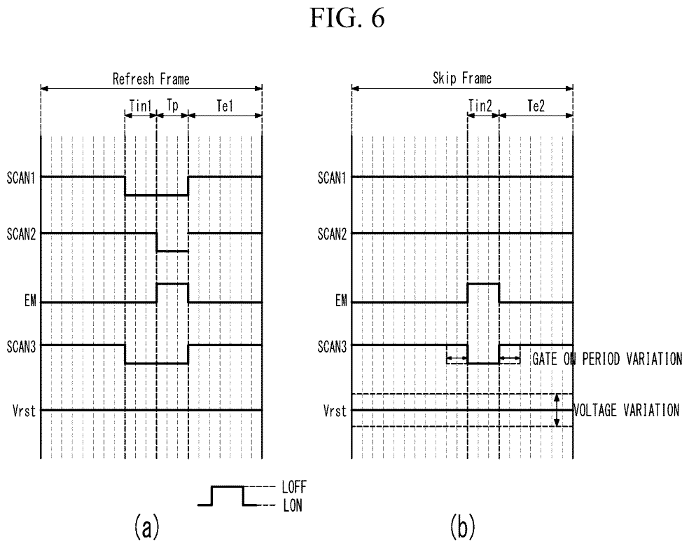

FIG. 5 is a diagram for describing an embodiment of a pixel circuit according to the present disclosure, and FIG. 6 is a diagram for describing an embodiment of a driving timing diagram for operating the pixel circuit illustrated in FIG. 5.

As illustrated in FIG. 5, a pixel circuit according to an embodiment of the present disclosure may include a light emitting device EL 110, a driving transistor D-TFT 120, a driving transistor controller 130, and an initialization switch TR_IN 140.

The driving transistor D-TFT, a plurality of transistors TR1 to TR4 included in the driving transistor controller 130, and the initialization switch TR_IN may each be implemented as a PMOS type including a semiconductor layer of LTPS. Accordingly, a gate on voltage LON of each of the transistors TR1 to TR4 (T1 to T8) may be a low-level voltage, and a gate off voltage LOFF may be a high-level voltage.

Each of the driving transistor D-TFT, the plurality of transistors TR1 to TR4 included in the driving transistor controller 130, and the initialization switch TR_IN may include a first electrode, a second electrode, and a gate electrode. One of the first electrode and the second electrode may be a source electrode, and the other of the first electrode and the second electrode may be a drain electrode.

The light emitting device EL, as described above with reference to FIGS. 1 to 3, may be implemented as an organic light emitting diode which emits light with a driving current I oled generated by the driving transistor D-TFT, and a parasitic capacitor C oled may be formed between an anode electrode and a cathode electrode of the light emitting device EL.

A second power line EVL2 may be connected to the cathode electrode of the light emitting device EL and may transfer a low-level voltage ELVSS, and the anode electrode of the light emitting device EL may be connected to a third node N3.

The driving transistor D-TFT may generate the driving current I oled which is to be supplied to the light emitting device EL.

The driving transistor D-TFT may include a first electrode (for example, a source electrode), a second electrode (for example, a drain electrode), and a gate electrode. A high-level voltage ELVDD may be supplied to the first electrode of the driving transistor D-TFT through the first power line EVL1, the second electrode may be connected to the fourth transistor TR4 and the anode electrode of the light emitting device EL through the third node N3, and the gate electrode may be connected to a second node N2.

The driving transistor D-TFT may be controlled based on a voltage applied to the second node N2 and may transfer, to the light emitting device EL, the driving current I oled flowing between the first and second electrodes (for example, the source electrode and the drain electrode), based on the voltage applied to the second node N2.

For example, when a gate-source voltage (hereinafter referred to as Vgs) of the driving transistor D-TFT is greater than a threshold voltage Vth, the driving transistor D-TFT may be gate-turned off, and when the gate-source voltage (hereinafter referred to as Vgs) is less than the threshold voltage Vth, the driving transistor D-TFT may be gate-turned on. The driving current I oled generated by the driving transistor D-TFT may vary in magnitude, based on a difference “Vgs-Vth” between the gate-source voltage Vgs and the threshold voltage Vth.

In response to a first gate control signal, the driving transistor controller 130 may control a voltage applied to the second node N2 to control a current flowing in the driving transistor D-TFT. To this end, the driving transistor controller 130 may include a capacitor CST and the plurality of transistors TR1 to TR4.

One electrode of the capacitor CST may be connected to a first node N1 where a data voltage Vdata corresponding to image data is charged in a refresh frame period, and the other electrode may be connected to the second node N2 connected to the gate electrode of the driving transistor D-TFT.

The first gate control signal may include a first scan signal SCAN1(N), a second scan signal SCAN2(N), and an emission control signal EM(N), which have different phases. The plurality of transistors TR1 to TR4 may include first to fourth transistors TR1 to TR4 controlled based on the first scan signal SCAN1(N), the second scan signal SCAN2(N), and the emission control signal EM(N). Each of the first to fourth transistors TR1 to TR4 may include a first electrode, a second electrode, and a gate electrode.

The first electrode of the first transistor TR1 may be connected to the second node N2 connected to the gate electrode of the driving transistor D-TFT, the second electrode may be connected to the second electrode of the driving transistor D-TFT, and the first scan signal SCAN1(N) may be applied to the gate electrode.

The first transistor TR1 may be controlled based on a voltage level of the first scan signal SCAN1(N). In response to the first scan signal SCAN1(N), the first transistor TR1 may be gate-turned on and may allow electricity to flow in the gate electrode and the second electrode of the driving transistor D-TFT. Accordingly, the driving transistor D-TFT may operate like a diode while the first transistor TR1 is being gate-turned on.

While the first transistor TR1 is being gate-turned on, the driving transistor D-TFT may be gate-turned on or gate-turned off based on the voltage applied to the second node N2.

The first transistor TR1 may be gate-turned on during a first initialization period Tin1 of a refresh frame and may apply a first voltage Vref to the second node N2 to initialize the second node N2, and during a programming period Tp, the first transistor TR1 may be gate-turned on and may apply, to the second node N2, a programming voltage where the high-level voltage ELVDD and the threshold voltage of the driving transistor D-TFT are reflected.

The data voltage Vdata may be supplied to the first electrode of the second transistor TR2, the second electrode may be connected to the first node N1, and the second scan signal SCAN2(N) may be applied to the gate electrode. The second transistor TR2 may be controlled based on a voltage level of the second scan signal SCAN2(N). The second transistor TR2 may apply the data voltage Vdata, supplied to the first electrode, to the first node N1 in the programming period Tp of the refresh frame, based on the second scan signal SCAN2(N).

The first electrode of the third transistor TR3 may be connected to the first node N1, the second electrode may be connected to a first voltage Vref source, and the emission control signal EM(N) may be applied to the gate electrode. The first electrode of the fourth transistor TR4 may be connected to the second electrode of the driving transistor D-TFT, the second electrode may be connected to the third node N3, and the emission control signal EM(N) may be applied to the gate electrode. The gate electrodes of the third and fourth transistors TR3 and TR4 may be connected to, in common, a gate line to which the emission control signal EM(N) is supplied.

The third and fourth transistors TR3 and TR4 may be gate-turned on based on the emission control signal EM(N) in first and second emission periods Te1 and Te2 and may be controlled so that the driving current I oled generated by the driving transistor D-TFT is supplied to the light emitting device EL.

During the first initialization period Tin1 of the refresh frame, the third transistor TR3 may be gate-turned on and may apply the first voltage Vref, which is a reference voltage, to the first node N1 to initialize the first node N1.

In a skip frame period after a refresh frame period, the initialization switch TR_IN may initialize the third node N3 connected to the anode electrode of the light emitting device EL in response to a second gate control signal which differs from the first gate control signal.

In the initialization switch TR_IN, a first electrode may be connected to a second voltage Vrst source which is a reset voltage, a second electrode may be connected to the third node N3 connected to the anode electrode of the light emitting device EL, and the second gate control signal may be applied to a gate electrode. The second gate control signal may be the third scan signal SCAN3(N) having a phase which differs from phases of the first and second scan signals SCAN1(N) and SCAN2(N) and may be applied through a gate line differing from a gate line to which the first gate control signal is applied.

Therefore, while the initialization switch TR_IN is being gate-turned on, the second voltage Vrst may be applied to the third node N3, and residual electric charges charged in the parasitic capacitor C oled formed between the anode electrode and the cathode electrode of the light emitting device EL may be reset.

In the pixel circuit according to the present embodiment, the first voltage Vref and the second voltage Vrst may have different levels from each other so as to minimize a luminance deviation.

The first voltage Vref may be supplied to the driving transistor controller 130 so as to minimize the first node N1 in the refresh frame period, and the second voltage Vrst may be supplied to the third node N3 through the initialization switch TR_IN so as to minimize the third node N3 in the skip frame period.

In more detail, in the refresh frame period, the first node N1 may be initialized by the first voltage Vref, and the second and third nodes N2 and N3 may be initialized by the second voltage Vrst, and in the skip frame period, the third node N3 except the first and second nodes N1 and N2 may be initialized by the second voltage Vrst.

In the pixel circuit according to the present embodiment, the gate electrode of the driving transistor D-TFT may be initialized to the second voltage Vrst having a level which differs from that of the first voltage Vref, and thus, the driving transistor D-TFT may be gate-turned off so that the gate-source voltage (hereinafter referred to as Vgs) of the driving transistor D-TFT is less than the threshold voltage Vth in the first initialization period Tin1. Therefore, the pixel circuit according to the present embodiment may prevent the occurrence of short circuit between the high-level voltage ELVDD and the first voltage Vref. Accordingly, the pixel circuit according to the present embodiment may prevent the first voltage Vref from increasing due to short circuit in the refresh frame period and may minimize a deviation between luminance occurring in the refresh frame period and luminance occurring in the skip frame period.

Moreover, the pixel circuit according to the present embodiment may control the third scan signal SCAN3(N) and the second voltage Vrst separately from the first gate control signal and the first voltage Vref to independently initialize the third node N3 except the first and second nodes N1 and N2. Accordingly, the pixel circuit according to the present embodiment may control a gate on period of the third scan signal SCAN3(N) and a level of the second voltage Vrst to precisely control the initial luminance of the display panel 10.

Therefore, the pixel circuit according to the present embodiment may minimize a luminance deviation between normal driving (for example, 120 Hz driving) performed based on only a refresh frame and low speed driving (for example, 60 Hz to 1 Hz driving) including a portion of a skip frame.

The pixel circuit according to the present embodiment may be driven based on a timing of each of the refresh frame and the skip frame illustrated in FIG. 6. A driving timing diagram illustrated in FIG. 6 may be an embodiment, and the pixel circuit according to the present embodiment is not limited to the driving timing illustrated in FIG. 6

The refresh frame may include a first initialization period Tin1, a programming period Tp, and a first emission period Te1 as in FIG. 6(a), and the skip frame may include a second initialization period Tin2 and a second emission period Te2 as in FIG. 6(b).

In the first initialization period Tin1 of the refresh frame, the first node N1 may be initialized by the first voltage Vref, and the second and third nodes N2 and N3 may be initialized by the second voltage Vrst. Accordingly, the capacitor CST connected to the first and second nodes N1 and N2 may be initialized, the driving transistor D-TFT connected to the second node N2 may be initialized, and the light emitting device EL connected to the third node N3 may be initialized.

A programming voltage including the high-level voltage ELVDD and the threshold voltage Vth of the driving transistor D-TFT may be set in the second node N2 in the programming period Tp. Furthermore, the third node N3 may be successively initialized in the programming period Tp succeeding the first initialization period Tin1. In FIG. 6, a case where the third node N3 is successively initialized is illustrated for example, but the inventive concept is not limited thereto.

In the first emission period Te1, the light emitting device EL may emit light, based on a programming voltage of the second node N2 where the data voltage Vdata and the first voltage Vref are reflected.

In the second initialization period Tin2 of the skip frame, the third node N3 connected to the anode electrode of the light emitting device EL except the first and second nodes N1 and N2 may be initialized by the second voltage Vrst.

In the second emission period Te2, the light emitting device EL may emit light, based on the same programming voltage as the programming voltage of the first emission period Te1. That is, a programming voltage of the second node N2 may be equal in the first and second emission periods Te1 and Te2.

To this end, the second node N2 may be floated during the second initialization period Tin2, the programming voltage of the second node N2 may be maintained to be equal to the programming voltage of the first emission period Te1 during the second initialization period Tin2, and the light emitting device EL may emit light in the second emission period Te2, based on the same voltage as the programming voltage of the first emission period Te1.

Moreover, as described above, based on a driving timing, even in a case where the programming voltage of the second node N2 is equal in the first and second emission periods Te1 and Te2, when a discharge speed of the capacitor CST is fast or slow, or a discharge speed of the parasitic capacitor C oled of the light emitting device EL is fast or slow due to a device characteristic or a process error, luminance of light emitted in the refresh fame period may differ from that of light emitted in the skip frame period.

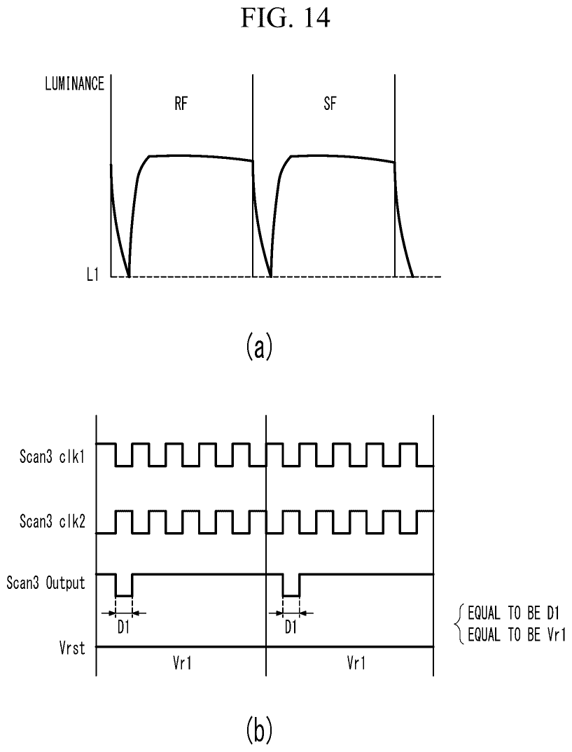

Based thereon, the present embodiment may be set so that the second voltage Vrst supplied to the third node N3 have different levels in the refresh period and the skip frame period. Also, the present embodiment may be set so that a length of a gate on period of the initialization switch TR_IN in the skip frame period differs from a length of a gate on period of the initialization switch TR_IN in the refresh frame period. This will be described below with reference to FIGS. 14 to 16.

In FIG. 5, the driving transistor D-TFT and the plurality of transistors included in the driving transistor controller 130 may each be a P-channel transistor, and thus, in the gate control signal applied in the refresh frame period and the skip frame period in FIG. 6, the gate on voltage LON may be a low-level voltage, and the gate off voltage LOFF may be a high-level voltage.

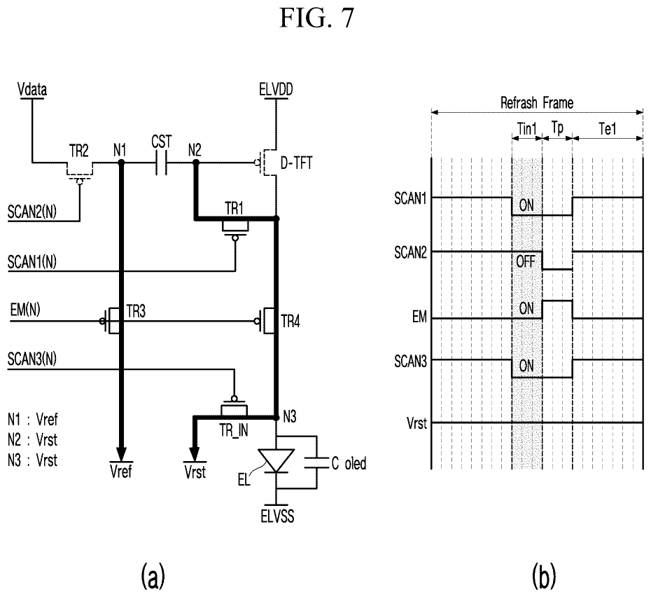

FIGS. 7 to 11 are diagrams for describing a pixel operation of FIG. 5 with respect to a driving timing of FIG. 6.

As illustrated in FIG. 7, in a first initialization period Tin1 of a refresh frame, first and third scan signals SCAN1(N) and SCAN3(N) and an emission control signal EM(N) may have a gate on voltage, and a second scan signal SCAN2(N) may have a gate off voltage. Accordingly, a first transistor TR1, an initialization switch TR_IN, and third and fourth transistors TR3 and TR4 may be gate-turned on, and a second transistor TR2 may be gate-turned off.

Therefore, a current path which is configured with a first node N1, the third transistor TR3, and a first voltage Vref source and is connected to one electrode of the capacitor CST may be formed, and a current path which is configured with a second node N2, the first transistor TR1, the fourth transistor TR4, the initialization switch TR_IN, and a second voltage Vrst source and is connected to the other electrode of the capacitor CST may be formed.

The first voltage Vref may be applied to the first node N1, the second voltage Vrst may be applied to the second node N2 and a third node N3, and a difference voltage between the first voltage Vref and the second voltage Vrst may be charged in the capacitor CST.

At this time, in the gate-source voltage Vgs of the driving transistor D-TFT, a difference voltage “Vrst-ELVDD” between the second voltage Vrst and the high-level voltage ELVDD may have a value which is greater than the threshold voltage Vth, the driving transistor D-TFT may be gate-turned off.

Therefore, in the first initialization period Tin1, the first node N1 may be initialized by the first voltage Vref, the second node N2 may be initialized by the second voltage Vrst, and the third node N3 may be initialized by the second voltage Vrst.

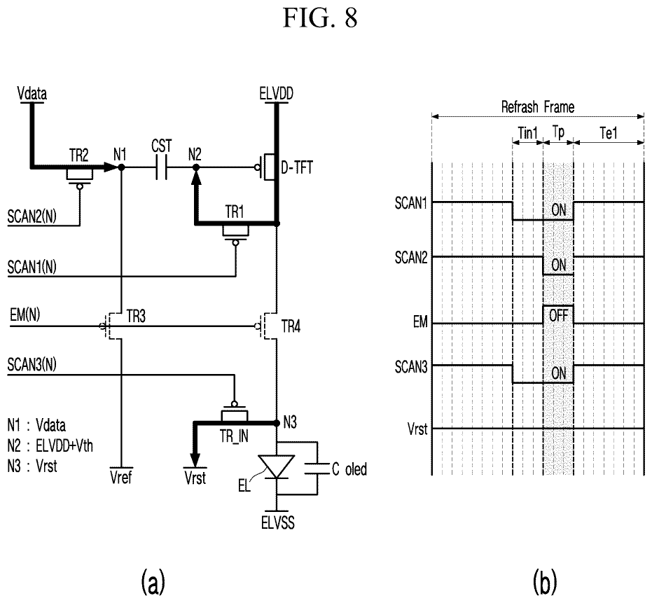

As illustrated in FIG. 8, in a programming period Tp of the refresh frame, the first to third scan signals SCAN1(N), SCAN2(N), and SCAN3(N) may have a gate on voltage, and the emission control signal EM(N) may have a gate off voltage. Therefore, the first and second transistors TR1 and TR2 and the initialization switch TR_IN may be gate-turned on, and the third and fourth transistors TR3 and TR4 may be gate-turned off. As the first transistor TR1 is gate-turned on, the first transistor TR1 may be diode-connected to the second electrode and the gate electrode of the driving transistor D-TFT.

As the second transistor TR2 is gate-turned on, a data voltage Vdata may be applied to the first node N1 connected to the one electrode of the capacitor CST.

In the second node N2 connected to the other side of the capacitor CST, the data voltage Vdata may be added to a difference voltage “Vrst-Vref” charged in the capacitor CST. Accordingly, the gate-source voltage Vgs of the driving transistor D-TFT may be instantaneously reduced by a voltage of the second node N2, and thus, the driving transistor D-TFT may be gate-turned on.

Accordingly, the high-level voltage ELVDD may be applied to the second node N2 through the driving transistor D-TFT and the first transistor TR1, and at this time, the threshold voltage Vth of the driving transistor D-TFT may be reflected in the high-level voltage ELVDD.

As a result, a programming voltage “ELVDD+Vth” including the high-level voltage ELVDD and the threshold voltage Vth may be applied to the second node N2.

In the programming period Tp, the second voltage Vrst may be applied to the third node N3, and thus, an initialization operation of the anode electrode may be continuously performed by the second voltage Vrst.

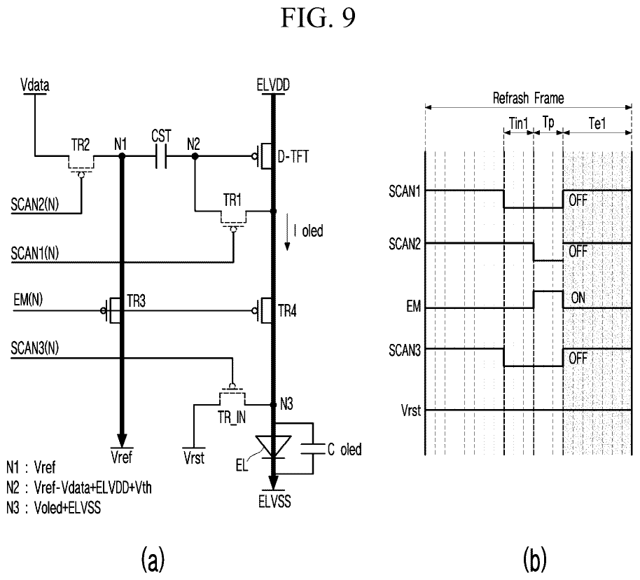

As illustrated in FIG. 9, in the first emission period Te1 of the refresh frame, the emission control signal EM(N) may have the gate on voltage, and the first to third scan signals SCAN1(N), SCAN2(N), and SCAN3(N) may have the gate off voltage. Accordingly, the third and fourth transistors TR3 and TR4 may be gate-turned on, and the first and second transistors TR1 and TR2 and the initialization switch TR_IN may be gate-turned off.

Therefore, the first voltage Vref may be applied to the first node N1 through the third transistor TR3. As the first voltage Vref is applied to the one electrode of the capacitor CST connected to the first node N1, a programming voltage of the second node N2 connected to the other electrode of the capacitor CST may be changed to a voltage “Vref−Vdata+ELVDD+Vth” including the high-level voltage ELVDD, the threshold voltage Vth of the driving transistor D-TFT, and a difference voltage between the first voltage Vref and the data voltage Vdata.

Accordingly, the gate-source voltage Vgs of the driving transistor D-TFT may be maintained to be a voltage which is less than the threshold voltage Vth, and thus, the driving transistor D-TFT may maintain a gate on state. Therefore, a current path configured with a high-level voltage ELVDD source, the driving transistor D-TFT, the fourth transistor TR4, and the light emitting device EL may be formed.

At thit time, the driving transistor D-TFT may generate a driving current I oled proportional to the square of a difference voltage “Vref−Vdat” between the first voltage Vref and the data voltage Vdata and may provide the driving current I oled to the light emitting device EL, and thus, the light emitting device EL may emit light.

That is, in a driving current “I oled=k (Vgs−Vth)²”,

Vgs=Vg−Vs=(Vref−Vdata+ELVDD+Vth)−ELVDD, and thus,

Vgs−Vth=Vref−Vdata.

Therefore, an equation of the driving current I oled generated by the driving transistor D-TFT may be expressed as the following Equation 1 irrelevant to the threshold voltage Vth of a driving element DT.

I oled=k(Vref−Vdata)² [Equation 1]

In Equation 1, k may denote a constant value determined by an electron mobility, a parasitic capacity, and a channel capacity of the driving element, Vref may denote the first voltage Vref, and Vdata may denote the data voltage Vdata.

As described above, as the driving current I oled is supplied to the light emitting device EL, the third node N3 may have a voltage “Voled+ELVSS” which is a sum of a voltage Voled of the light emitting device EL and the low-level voltage ELVSS.

A state of the first emission period Te1 may be maintained until before the second initialization period Tin2 of the skip frame. Therefore, when the light emitting device emits light with the data voltage Vdata in the first emission period Te1, emission of light may be maintained until before the second initialization period Tin2, and when the light emitting device does not emit light in the first emission period Te1, a state where light is not emitted may be maintained until before the second initialization period Tin2.

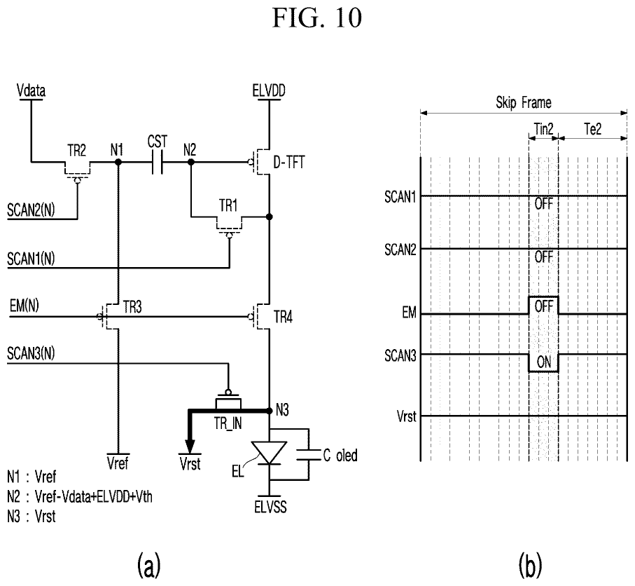

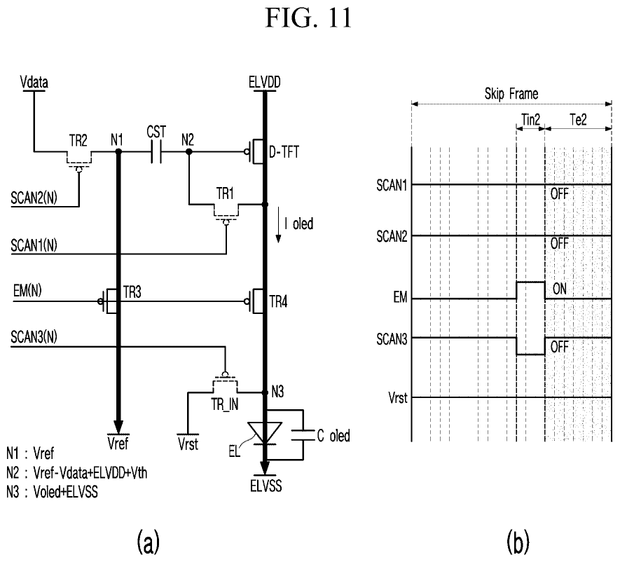

As illustrated in FIG. 10, in the second initialization period Tin2 of the skip frame, the third scan signal SCAN3(N) may have the gate on voltage, and the first and second scan signals SCAN1(N) and SCAN2(N) and the emission control signal EM(N) may have the gate off voltage. Accordingly, the initialization switch TR_IN may be gate-turned on, and the first to fourth transistors TR1 to TR4 may be gate-turned off. Also, the driving transistor D-TFT may be gate-turned off.

Therefore, in the second initialization period Tin2 of the skip frame, the second voltage Vrst may be independently applied to the third node N3, and thus, the anode electrode except the first and second nodes N1 and N2 may be initialized, and the capacitor CST and may driving transistor D-TFT may not be initialized.

In the second initialization period Tin2, as the first and second transistors TR1 and TR2 and the driving transistor D-TFT are gate-turned off, the first and second nodes N1 and N2 connected to both ends of the capacitor CST may be floated, and voltages of the first and second nodes N1 and N2 in the first emission period Te1 may be intactly maintained. Accordingly, in the second initialization period Tin2, a voltage of the first node N1 may be the first voltage Vref, and a voltage of the second node N2 may be the programming voltage “Vref−Vdata+ELVDD+Vth”.

As illustrated in FIG. 11, in the second emission period Te2 of the skip frame, the emission control signal EM(N) may have the gate on voltage, and the first to third scan signals SCAN1(N), SCAN2(N), and SCAN3(N) may have the gate off voltage. Accordingly, the third and fourth transistors TR3 and TR4 may be gate-turned on, and the first and second transistors TR1 and TR2 and the initialization switch TR_IN may be gate-turned off.

As the third transistor TR3 is gate-turned on, the first voltage Vref may be applied to the first node N1. As the first voltage Vref equal to a voltage of the first node N1 of the second initialization period Tin2 is applied in the second emission period Te2, the first node N1 may intactly maintain the first voltage Vref, and a programming voltage of the second node N2 may be intactly maintained in the second emission period Te2 succeeding the second initialization period Tin2. Therefore, in the second emission period Te2, the programming voltage of the second node N2 may be “Vref-Vdata+ELVDD+Vth”. Accordingly, the driving transistor D-TFT may be gate-turned on to generate the driving current I oled and may provide the driving current I oled to the light emitting device EL.

A magnitude of the driving current I oled generated by the driving transistor D-TFT during the second emission period Te2 may be equal to that of the driving current I oled generated by the driving transistor D-TFT during the first emission period Te1. Accordingly, the light emitting device may emit light having the same brightness and intensity during the first emission period Te1 of the refresh frame and the second emission period Te2 of the skip frame.

As described above, the programming voltage of the second node N2 may be equal in the first and second emission periods Te1 and Te2, and thus, a luminance deviation between the refresh frame and the skip frame may be minimized.

Hereinafter, an effect of minimizing a luminance deviation in a pixel circuit and a driving method thereof according to an embodiment of the present disclosure will be described in comparison with a pixel circuit according to a comparative example.

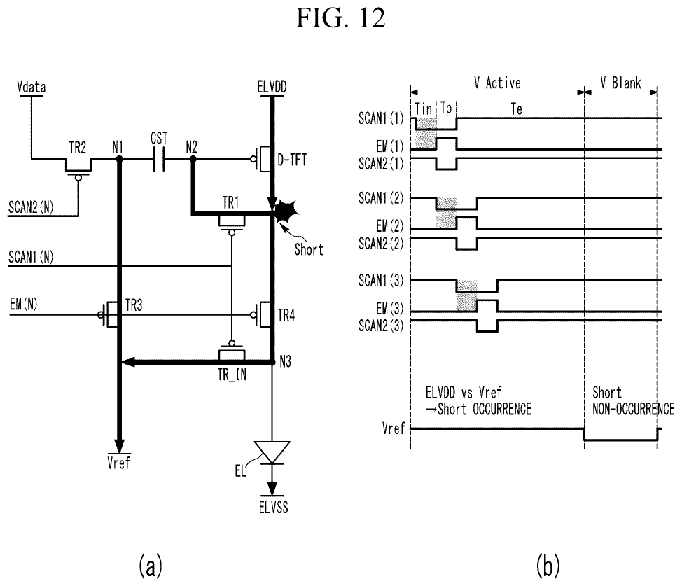

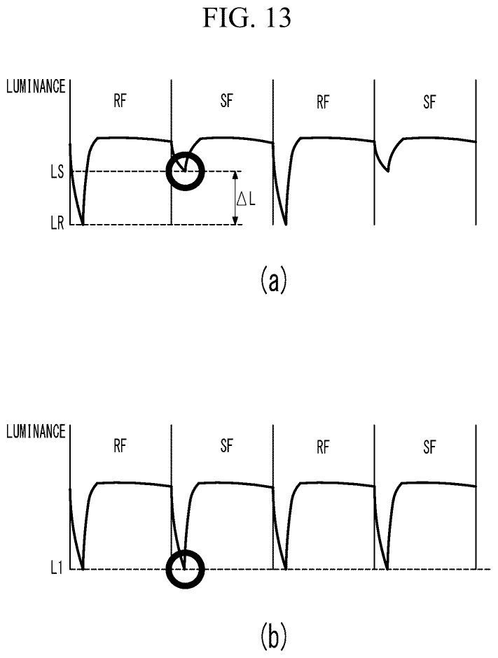

FIG. 12 is a diagram for describing an embodiment of a pixel and an embodiment of a driving timing according to a comparative example, and FIG. 13 is a diagram for describing a comparison of effects of a pixel circuit according to the comparative example of FIG. 12 and a pixel circuit according to the embodiment of FIG. 5.

FIG. 12(a) illustrates a pixel circuit according to the comparative example, and FIG. 12(b) illustrates a driving timing of the pixel circuit according to the comparative example.

As illustrated in FIG. 12(a), in the pixel circuit according to the comparative example, a light emitting device EL, a driving transistor D-TFT, first to fourth transistors TR1 to TR4, and an initialization switch TR_IN may be equally arranged compared to the pixel circuit according to an embodiment of the present disclosure illustrated in FIG. 5.

A gate control signal of the initialization switch TR_IN may not be independent, and a first scan signal SCAN1(N) for controlling the first transistor TR1 may be used as the gate control signal of the initialization switch TR_IN together. Also, a first voltage Vref for initializing a first node N1 may be connected to the initialization switch TR_IN.

In the comparative example, as in FIG. 12(b), during an initialization period Tin of a vertical active period (V Active) of a refresh frame RF, the first scan signal SCAN1(N) and an emission control signal EM(N) may have a gate on voltage, and a second scan signal SCAN2(N) may have a gate off voltage.

Therefore, as in FIG. 12(a), the first node N1 and second and third nodes N2 and N3 may be initialized to the first voltage Vref during the initialization period Tin. Based on the driving transistor D-TFT and the initialization switch TR_IN which are gate-turned on during the initialization period Tin, the first voltage Vref and a high-level voltage ELVDD may be short-circuited with each other, and thus, the first voltage Vref may abnormally increase.

In a vertical blank period (V Blank) of the refresh frame RF, there may be no operation of initializing an anode electrode of the light emitting device EL, and thus, short circuit between the first voltage Vref and the high-level voltage ELVDD may not occur, and the first voltage Vref may recover to a default value.

In other words, the first voltage Vref may increase based on short circuit between the first voltage Vref and the high-level voltage ELVDD in the vertical blank period (V Blank) of the refresh frame RF, and short circuit may not occur in the vertical blank period (V Blank) of the refresh frame RF, and thus, the first voltage Vref may be lowered to an original voltage.

An electric potential variation of the first voltage Vref with respect to a time may cause an undesired luminance deviation. For example, in a case where low speed driving is to be performed by using the pixel circuit of the comparative example, the level distortion of the first voltage Vref may cause a problem where the luminance of a display panel is distorted, and due to the electric potential variation of the first voltage Vref, the luminance of a refresh frame RF period and the luminance of a skip frame SF period may differ from each other.

To solve the luminance deviation described above, in the comparative example, in a case for initializing an anode electrode of the light emitting device EL in the skip frame SF succeeding the refresh frame RF, up to a voltage of a second node N2 may be changed, and due to this, data distortion may occur. That is, when the gate on voltage is applied to the first scan signal SCAN1(N) so as to initialize the anode electrode, the first transistor TR1 as well as the initialization switch TR_IN may be gate-turned on together.

Therefore, in the comparative example, data distortion may occur in the second node N2 connected to a gate electrode of the driving transistor D-TFT, and thus, it is impossible to initialize the anode electrode of the light emitting device EL in the skip frame SF. Also, in a case where low speed driving is to be performed by using the pixel circuit of the comparative example, the first voltage Vref may maintain an original voltage in the skip frame SF. As a result, an electric potential of the first voltage Vref may be higher in the refresh frame RF than the skip frame SF.

As described above, in the comparative example, because it is unable to independently initialize the anode electrode, a luminance deviation may occur when performing low speed driving (for example, 60 Hz to 1 Hz driving), compared to normal driving (for example, 120 Hz driving).

FIG. 13(a) is a diagram for describing a luminance deviation according to the comparative example, and FIG. 13(b) is a diagram for describing an effect of minimizing a luminance deviation according to an embodiment of the present disclosure.

In a case where low speed driving is performed by using the pixel circuit of the comparative example, because it is impossible to initialize the anode electrode in the skip frame SF, a luminance deviation may occur as luminance relatively increases in the skip frame SF, compared to the refresh frame RF. In the comparative example, as in FIG. 13(a), luminance LS in the skip frame SF may be ΔL higher than luminance LR in the refresh frame RF.

On the other hand, in the pixel circuit according to an embodiment of the present disclosure, because it is possible to independently initialize the anode electrode in the skip frame SF also, a luminance deviation between a refresh frame RF period and a skip frame SF period may be minimized. As in FIG. 13(b), the luminance of the skip frame SF and the luminance of the refresh frame RF may be L1 and may be equal to each other.

Moreover, an embodiment of the present disclosure may independently control the initialization switch TR_IN with the third scan signal SCAN3(N) and the second voltage Vrst in the skip frame SF period to initialize the third node N3 except the first and second nodes N1 and N2, and thus, it may be possible to set the initial luminance of the display panel 10.

In more detail, in the display panel 10, an electrical characteristic should be uniform in all pixels PIX, but due to a process deviation and a device characteristic deviation, a parasitic capacitor C oled characteristic of the light emitting device EL or the capacitor CST may differ from a target characteristic. Accordingly, a discharge characteristic of the capacitor CST may be faster or slower than a target characteristic, and the amount of discharge of the parasitic capacitor C oled of the light emitting device EL may be excessively large or small.

Therefore, even when the programming voltage of the second node N2 is set to be equal in the first and second emission periods Te1 and Te2, the luminance of the refresh frame RF may differ from the luminance of the skip frame SF.

Hereinafter, in a case where the luminance of the refresh frame RF differs from the luminance of the skip frame SF due to a process deviation and a device characteristic deviation, a method of improving the case will be described.

FIG. 14 is a diagram for describing a first embodiment of a setting of a second voltage Vrst and a setting of a length of a gate on period of the initialization switch TR_IN illustrated in FIGS. 4 and 5.

As illustrated in FIG. 14(a), in a case where the luminance of a refresh frame RF and the luminance of a skip frame SF are L1 and are equal to each other, gate on periods of the initialization switch TR_IN in the refresh frame RF and the skip frame SF may be set to D1 to be equal to each other as illustrated in FIG. 14(b), and second voltages Vrst in the refresh frame RF and the skip frame SF may be set to Vr1 to be equal to each other.

However, even when a programming voltage of the second node N2 is set to be equal in first and second emission periods Te1 and Te2, the luminance of the refresh frame RF and the luminance of the skip frame SF may differ based on a characteristic of the capacitor CST, a parasitic capacitor C oled characteristic of the light emitting device EL, or whether there is a programming period Tp or not.

In this case, the second voltage Vrst may be set to have different levels in a refresh frame RF period and a skip frame SF period, and thus, a luminance deviation between the refresh frame RF and the skip frame SF may be improved. The timing controller 11 may control an output voltage of the power circuit 20 by using inter-integrated circuit (I2C) or serial peripheral interface (SPI) communication, and thus, a level of the second voltage Vrst may be differently set.

Moreover, in the present embodiment, a length of a gate on period of the initialization switch TR_IN in the skip frame SF period and a length of a gate on period of the initialization switch TR_IN in the refresh frame RF period may be differently set, and thus, a luminance deviation between the refresh frame RF and the skip frame SF may be improved. The timing controller 11 may control widths of first and second clock signals Scan3 clk1 and Scan3 clk2 output to the gate driver 13 so as to generate a third scan signal SCAN3(N), and thus, the gate on periods of the initialization switch TR_IN may be differently set.

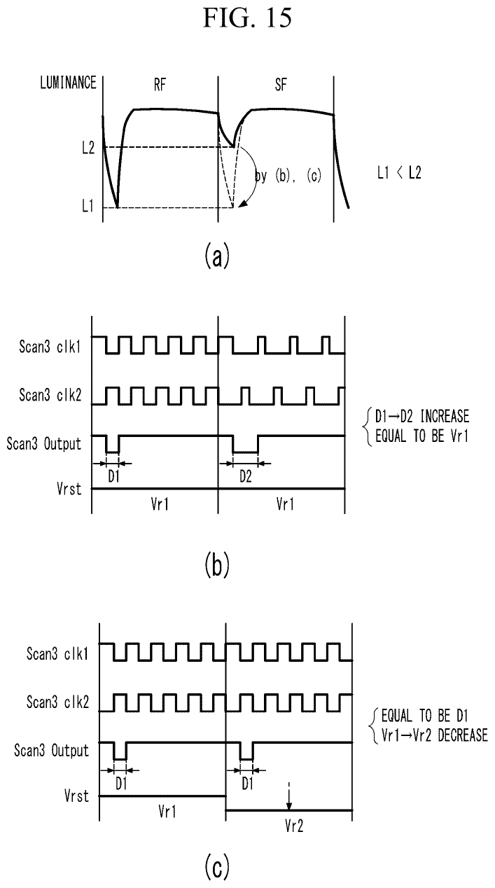

FIG. 15 is a diagram for describing a second embodiment of a setting of the second voltage Vrst and a setting of a length of the gate on period of the initialization switch TR_IN illustrated in FIGS. 4 and 5.

Based on the timing diagram of FIG. 6, even when a pixel circuit is driven so that programming voltage of the second node N2 is set to be equal in first and second emission periods Te1 and Te2, there may be no programming period Tp in the skip frame SF, and thus, comparing with a refresh frame RF, the second emission period Te2 may increase by a corresponding period, or due to the other process deviation or device characteristic deviation, as in FIG. 15(a), luminance L2 of the skip frame SF may occur to be higher than luminance L1 of the refresh frame RF.

In this case, in the present embodiment, as in FIG. 15(b), it may be set that a gate on period D2 of the initialization switch TR_IN in a skip frame SF increases more than a gate on period D1 of a refresh frame RF, in a state where a second voltage Vrst is equally maintained to be Vr1 in the refresh frame RF and the skip frame SF.

Therefore, the present embodiment may relatively longer perform an initialization operation of an anode electrode in a second initialization period Tin2 of the skip frame SF and may allow the amount of residual electric charge of the parasitic capacitor C oled of the light emitting device EL to be relatively more discharged. Accordingly, the present embodiment may lower the luminance of the skip frame SF from L2 to L1 and may thus improve a luminance deviation.

Alternatively, in the present embodiment, as in FIG. 15(c), it may be set that the second voltage Vrst in the skip frame SF is down-changed or lowered to a Vr2 voltage which is lower than a Vr1 voltage of the refresh frame RF, in a state where the gate on period of the initialization switch TR_IN is equally maintained to be D1 in the refresh frame RF and the skip frame SF.

Accordingly, the present embodiment may more delay a timing at which the parasitic capacitor C oled of the light emitting device EL is charged for emission of light in the second emission period Te2 of the skip frame SF, and thus, may lower the luminance of the skip frame SF from L2 to L1 and may thus improve a luminance deviation.

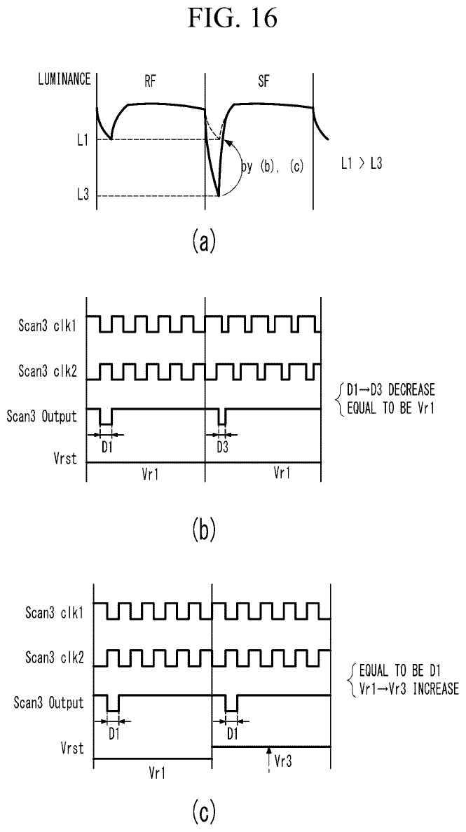

FIG. 16 is a diagram for describing a third embodiment of a setting of the second voltage Vrst and a setting of the gate on period of the initialization switch TR_IN illustrated in FIGS. 4 and 5.

Even when the pixel circuit is driven so that a programming voltage of the second node N2 is set to be equal in the first and second emission periods Te1 and Te2, because a data voltage Vdata is not written in a skip frame SF like a refresh frame RF, the capacitor CST may be discharged, or due to the other process deviation or device characteristic deviation, as in FIG. 16(a), luminance L3 of the skip frame SF may occur to be lower than luminance L1 of the refresh frame RF.

In this case, in the present embodiment, as in FIG. 16(b), it may be set that a gate on period D3 of the initialization switch TR_IN in a skip frame SF decreases more or is shorter than a gate on period D1 of a refresh frame RF, in a state where a second voltage Vrst is equally maintained to be Vr1 in the refresh frame RF and the skip frame SF.

Therefore, the present embodiment may relatively more shorten the gate on period D3 of the initialization switch TR_IN in a second initialization period Tin2 of the skip frame SF, and thus, the present embodiment may relatively shorter perform an initialization operation of the anode electrode and may allow the amount of residual electric charge of the parasitic capacitor C oled of the light emitting device EL to be relatively less discharged. Accordingly, the present embodiment may increase the luminance of the skip frame SF from L3 to L1 and may thus improve a luminance deviation.

Alternatively, in the present embodiment, as in FIG. 16(c), it may be set that the second voltage Vrst in the skip frame SF is up-changed or increase to a Vr3 voltage which is higher than a Vr1 voltage of the refresh frame RF, in a state where the gate on period of the initialization switch TR_IN is equally maintained to be D1 in the refresh frame RF and the skip frame SF.

Accordingly, the present embodiment may more quicken a timing at which the parasitic capacitor C oled of the light emitting device EL is charged in the second emission period Te2 of the skip frame SF, and thus, may increase the luminance of the skip frame SF from L3 to L1 and may thus improve a luminance deviation.

In FIGS. 15 and 16, to improve a luminance deviation, a case where the gate on period of the initialization switch TR_IN is set to be relatively long or short and a case where a level of the second voltage Vrst supplied to the skip frame SF is set to be relatively high or low has been described separately, but such two methods may be used together or may be used to be merged.

As described above, the display apparatus and the driving method thereof according to the present disclosure may include the initialization switch TR_IN independently controlled by the third scan signal SCAN3(N) and the second voltage Vrst, and thus, may independently initialize only the third node N3 connected to the anode electrode without affecting voltages of the first and second nodes N1 and N2 connected to the capacitor CST and the driving transistor D-TFT, thereby minimizing a luminance deviation between the refresh frame RF and the skip frame SF in low speed driving.

According to the embodiments of the present disclosure, an electroluminescent display apparatus may include an initialization switch for initializing an anode electrode of a light emitting device, separately from a driving transistor controller, and a gate control signal supplied to the initialization switch may be separated from another gate control signal supplied to the driving transistor controller, and thus, a luminance deviation between a refresh frame and a skip frame may be minimized.

In a driving method of the electroluminescent display apparatus according to the embodiments of the present disclosure, a gate electrode of a driving transistor may be floated while the anode electrode of the light emitting device is being initialized, and a programming voltage applied to the gate electrode of the driving transistor may be equally maintained in a first emission period of the refresh frame and a second emission period of the skip frame. As a result, the luminance deviation between the refresh frame and the skip frame may be minimized.

The effects according to the present disclosure are not limited to the above examples, and other various effects may be included in the specification.

Although various example embodiments of the present disclosure have been described in detail with reference to the accompanying drawings, the present disclosure is not limited thereto and may be embodied in many different forms without departing from the technical concept of the present disclosure. Therefore, the example embodiments of the present disclosure are provided for illustrative purposes only and are not intended to limit the scope of the present disclosure. It will be apparent to those skilled in the art that various modifications and variations can be made in the present disclosure without departing from the scope of the disclosure. Thus, it is intended that the present disclosure covers the modifications and variations of this disclosure provided that they come within the scope of the claims and their equivalents.

What is claimed is:

1. An electroluminescent display apparatus, comprising:
a display panel including a plurality of pixels; and
a driving circuit configured to drive the display panel,
wherein each of the plurality of pixels comprises:
a light emitting device;
a driving transistor configured to generate a driving current to be supplied to the light emitting device;
a driving transistor controller including a capacitor, including one electrode connected to a first node charged with a data voltage corresponding to image data in a refresh frame period and the other electrode connected to a second node connected to a gate electrode of the driving transistor, and a plurality of transistors configured to control a current flowing in the driving transistor; and
an initialization switch configured to initialize a third node connected to an anode electrode of the light emitting device in response to a second gate control signal differing from the first gate control signal, in a skip frame period after the refresh frame period.

2. The electroluminescent display apparatus of claim 1, wherein:
a first voltage is supplied to the driving transistor controller so as to initialize the first node in the refresh frame period and a second voltage is supplied to the third node through the initialization switch so as to initialize the third node in the skip frame period; and
the first voltage and the second voltage have different levels from each other.

3. The electroluminescent display apparatus of claim 2, wherein:
in the refresh frame period, the first node is initialized by the first voltage, and the second and third nodes are initialized by the second voltage; and
in the skip frame period, the third node except the first and second nodes is initialized by the second voltage.

4. The electroluminescent display apparatus of claim 3, wherein the second voltage has different levels in the refresh frame period and the skip frame period.

5. The electroluminescent display apparatus of claim 3, wherein a length of a gate on period of the initialization switch in the skip frame period differs from a length of a gate on period of the initialization switch in the refresh frame period.

6. The electroluminescent display apparatus of claim 2, wherein:
the refresh frame period comprises:
a first initialization period where the first and second nodes are initialized;
a programming period where a programming voltage including a threshold voltage of the driving transistor is set in the second node; and
a first emission period where the light emitting device emits light with the programming voltage of the second node;
the skip frame period comprises:
a second initialization period where the third node is initialized by the second voltage; and
a second emission period where the light emitting device emits light with the programming voltage of the second node after the second initialization period; and
the programming voltage of the second node is equal to each other in the first and second emission periods.

7. The electroluminescent display apparatus of claim 6, wherein the programming voltage of the second node comprises a threshold voltage of the driving transistor and a difference voltage between the first voltage and the data voltage.

8. The electroluminescent display apparatus of claim 2, wherein:
the first gate control signal comprises a first scan signal, a second scan signal, and an emission control signal each having different phases; and
the plurality of transistors of the driving transistor controller comprise:
a first transistor including a first electrode connected to the second node, a second electrode connected to a second electrode of the driving transistor, and a gate electrode to which the first scan signal is applied;
a second transistor including a first node supplied with the data voltage, a second electrode connected to the first node, and a gate electrode to which the second scan signal is applied;
a third transistor including a first electrode connected to the first node, a second electrode connected to a voltage source of the first voltage, and a gate electrode to which the emission control signal is applied; and
a fourth transistor including a first electrode connected to the second electrode of the driving transistor, a second electrode connected to the third node, and a gate electrode to which the emission control signal is applied.

9. The electroluminescent display apparatus of claim 8, wherein:
the initialization switch comprises a first electrode connected to a voltage source of the second voltage, a second node connected to the third node, and a gate electrode to which the second gate control signal is applied; and
the second gate control signal is a third scan signal having a phase which differs from phases of the first and second scan signals.

10. A driving method of an electroluminescent display apparatus including a capacitor, including one electrode connected to a first node charged with a data voltage and the other electrode connected to a second node, and a driving transistor including a first electrode connected to a high-level voltage source, a second electrode connected to a third node connected to an anode electrode of a light emitting device, and a gate electrode connected to the second node, the driving method comprising:
a first initialization operation of initializing the first node with a first voltage and initializing the second and third nodes with a second voltage in a refresh frame period;
a programming operation of setting a programming voltage, including a threshold voltage of the driving transistor, in the second node in the refresh frame period;
a first emission operation of emitting light by using the light emitting device with the programming voltage of the second node in the refresh frame period;
a second initialization operation of initializing the third node with the second voltage in a skip frame period after the refresh frame period; and
a second emission operation of emitting light by using the light emitting device with the programming voltage of the second node in the skip frame period,
wherein the second node is floated in the second initialization operation.

11. The driving method of claim 10, wherein the first voltage and the second voltage have different levels from each other.

12. The driving method of claim 10, wherein a voltage level of the second voltage supplied in the second initialization operation differs from a voltage level of the second voltage supplied in the first initialization operation.

13. The driving method of claim 10, wherein a length of a period of initializing the third node in the second initialization operation differs from a length of a period of initializing the third node in the first initialization operation.

14. The driving method of claim 10, wherein the programming voltage of the second node is equal to each other in the first and second emission periods.
